(19) United States
(12) Patent Application Publication
(10) Pub. No.: US 2016/0054462 A1
(43) Pub. Date: Feb. 25, 2016

(54) LOGGING DATA IDENTIFICATION SYSTEM USING REFLECTION METADATA

(71) Applicant: Halliburton Energy Services, Inc., Houston, TX (US)

(72) Inventors: Michael Williams, Houston, TX (US); Mauricio Pachon, Spring, TX (US); James Wang, Bellaire, TX (US)

(21) Appl. No.: 14/782,710

(22) PCT Filed: May 7, 2013
(86) PCT No.: PCT/US2013/039896

§ 371 Date: Oct. 6, 2015

(51) Int. Cl. G01V 1/28; G01V 1/34

(52) U.S. Cl. CPC G01V 1/28; G01V 1/34; G01V 2210/74

(57) ABSTRACT

A system for identifying logging data is disclosed. The system may include one or more logging data assemblies. The logging data assemblies may include a plurality of raw logging data, one or more application components, logging data metadata associated with at least one of the raw logging data, and application component metadata associated with the one or more application components. The system may further include an application program for receiving the logging data metadata and application component metadata using a reflection mechanism. The application program may use the application component metadata to convert the raw logging data to an output answer.

### BACKGROUND

Hydrocarbons, such as oil and gas, are commonly obtained from subterranean formations. The development of subterranean operations and the processes involved in removing hydrocarbons from a subterranean formation are complex. Typically, subterranean operations involve a number of different steps such as, for example, drilling a wellbore at a desired well site, treating the wellbore to optimize production of hydrocarbons, and performing the necessary steps to produce and process the hydrocarbons from the subterranean formation.

Modern oil field operations demand a great quantity of information relating to the parameters and conditions encountered downhole. Such information may include petrophysical characteristics of the formation traversed by the wellbore, physical properties of fluid, and data relating to the size and configuration of the wellbore itself. The collection of information relating to conditions downhole, which is commonly referred to as “logging,” can be performed by several methods, including wireline logging, logging-while-drilling (“LWD”), drillpipe conveyed logging, and coil tubing conveyed logging. A variety of logging tools are available for use with each of these methods.

Once the logging data is collected, software may be used to analyze the logging data and retrieve details relating to the formation, fluid, and bore hole. Typically, a specific software is designed for use with specific logging data. For example, if the logging data is in text format, specific software designed for use with text data must be used to retrieve the data. The identification and implementation of appropriate software for a particular set of logging data may prove time consuming. As a result, it may take a great deal of time to import and manage logging data before specific details may be retrieved using the appropriate software. Accordingly, it is desirable to provide a system and method of identifying the logging data that uses embedded algorithms to produce an output answer without prior knowledge of the data format.

### BRIEF DESCRIPTION OF THE DRAWINGS

FIG. 1 is a block diagram of a system for identifying logging data using a reflection mechanism, in accordance with certain embodiments of the present disclosure.

FIG. 2 is a flowchart depicting a method of identifying logging data using a reflection mechanism, in accordance with certain embodiments of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and are not exhaustive of the scope of the disclosure.

### DETAILED DESCRIPTION OF THE DRAWINGS

Illustrative embodiments of the present disclosure are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time-consuming, but would nevertheless be a routine undertaking for those of ordinary skill in the art having the benefit of the present disclosure.

To facilitate a better understanding of the present disclosure, the following examples of certain embodiments are given. In no way should the following examples be read to limit, or define, the scope of the invention. Embodiments of the present disclosure may be applicable to horizontal, vertical, deviated, or otherwise nonlinear wellbores in any type of subterranean formation. Embodiments may be applicable to injection wells as well as production wells, including hydrocarbon wells.

The terms “couple” or “couples” as used herein are intended to mean either an indirect or a direct connection. Thus, if a first device couples to a second device, that connection may be through a direct connection, or through an indirect mechanical or electrical connection via other devices and connections. The term “uphole” as used herein means along the drillstring or the hole from the distal end towards the surface, and “downhole” as used herein means along the drillstring or the hole from the surface towards the distal end.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (“RAM”), one or more processing resources such as a central processing unit (“CPU”) or hardware or software control logic, ROM, and/or other types of nonvolatile memory. Additional components of the information handling system may include one or more disk drives, one or more network ports for communication with external devices as well as various input and output (“I/O”) devices, such as a keyboard, a mouse, and a video display. The information handling system may also include one or more buses operable to transmit communications between the various hardware components.

For the purposes of this disclosure, computer-readable media may include any instrumentality or aggregation of instrumentalities that may retain data and/or instructions for a period of time. Computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (“EEPROM”), and/or flash memory; and/or any combination of the foregoing.

The present application relates generally to improving performance of subterranean operations and more specifically, to a method and system for improving analysis of logging data using reflection metadata.

The term “reflection” as used herein refers to an application programming interface (“API”) that refers to the ability to read and/or modify metadata at runtime. The term “metadata” as used herein refers to data which provides information about one or more aspects of a data file. Data reflection may be utilized to read data from a database and selectively transmit data from that database to another database. Applying data reflection to well logging data would provide a universal interface that may allow any application to retrieve information about the logging data without prior knowledge of the data format.

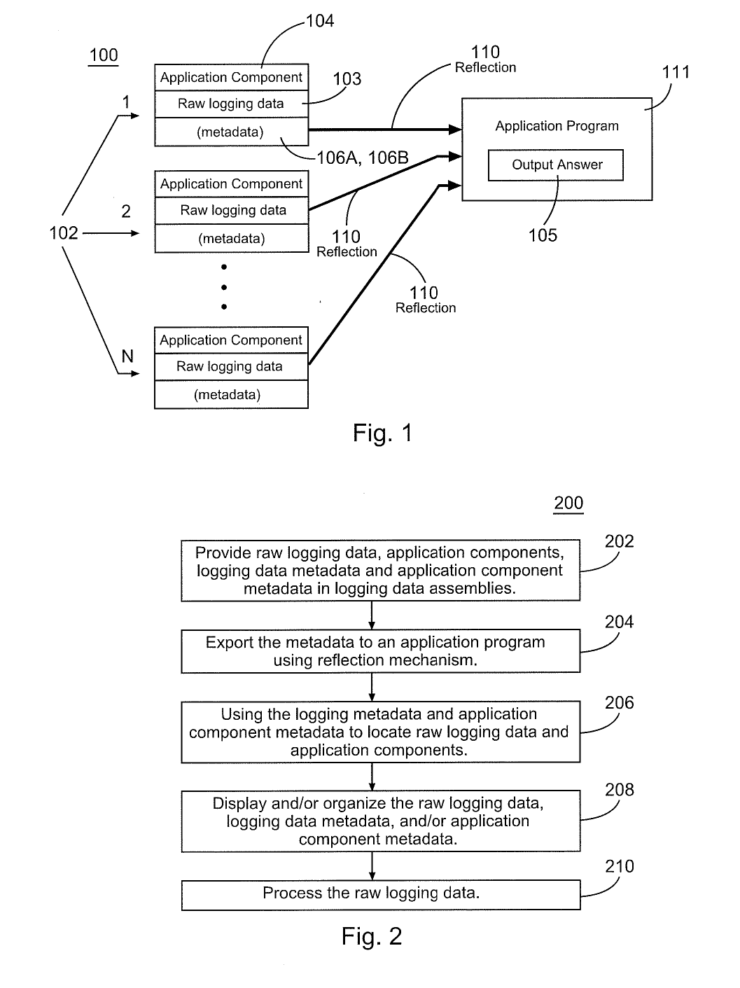

Referring to FIG. 1, a system for identifying logging data using a reflection mechanism in accordance with certain embodiments of the present disclosure is denoted generally with reference number 100. The system 100 may include one or more logging data assemblies 102. The logging data assemblies 102 may include a plurality of raw logging data 103 and one or more application components 104. The raw logging data 103 may include raw data from all sensors, time and depth data, well information, parameter data, direction data, hole diameter data, calibration data and bore hole formation data. Application components 104 may include one or more algorithms, for example, algorithms for calculating the porosity of a fluid and algorithms for calculating petrophysical properties of fluid and formation properties. Application components 104 may further include definitions of the inputs and outputs of the algorithms, algorithm mnemonics, a plotting component, and a calibration component.

The logging data assemblies 102 may be any suitable computer-readable media which can store data. The logging data assemblies 102 may further comprise logging data metadata 106A associated with the raw logging data 103 and application component metadata 106B associated with the one or more application components 104. The logging data metadata 106A may describe certain logging data properties, including, but not limited to, corresponding well information, customer information, location (i.e., global positioning system) information, run information, sensor information, variable information and calibration data, and/or a combination thereof. The application component metadata 106B may include, but is not limited to, application metadata and relationship metadata. Application metadata describes the functions of the application component 104 in terms of input, output, and how to trigger the functions of the one or more application components 104. The application metadata may describe how to activate the algorithm within the application component 104 and how to run such algorithm. Relationship metadata describes the relationship between the raw logging data 103 and the application component 104. Specifically, the relationship metadata may act as a bridge to relate the raw logging data 103 with the application component 104.

The system 100 may further include a reflection mechanism, denoted generally with reference number 110. The reflection mechanism 110 may be used to read the logging data metadata 106A and/or the application component metadata 106B. Specifically, the logging data metadata 106A and the application component metadata 106B may include a plurality of data types. The reflection mechanism 110 may use the data types of the logging data metadata 106A and the application component metadata 106B to instantiate multiple objects out of the metadata. As would be appreciated by one of ordinary skill in the art with the benefit of this disclosure, any reflection mechanism known to those of ordinary skill in the art may be used to read the logging data metadata 106A and/or the application component metadata 106B. For example, one type of reflection mechanism known to those of ordinary skill in the art is the Microsoft.Net reflection technology.

The system 100 may further include an Application Program 111. The Application Program 111 may utilize the reflection mechanism 110 to obtain the logging data metadata 106A and/or the application component metadata 106B. Once the Application Program 111 has obtained all of the logging data metadata 106A and/or the application component metadata 106B from the logging data assembly 102, the Application Program 111 may use the logging data metadata 106A and/or the application component metadata 106B to locate the raw logging data 103 and application components 104. Once the Application Program 111 locates the applications components 104, the Application Program 111 may have access to the algorithms, inputs and outputs of the algorithms, algorithm mnemonics, the plotting component, and the calibration component.

In certain embodiments, the Application Program 111 may display the logging data metadata 106A and/or the application component metadata 106B to a user. The Application Program 111 may sort and/or organize the logging data metadata 106A and/or the application component metadata 106B. In certain embodiments, the Application Program 111 may sort and/or organize the logging data metadata 106A and/or the application component metadata 106B in response to one or more search criteria. The search criteria may be based on any type of logging data metadata 106A and/or the application component metadata 106B present in the Application Program 111 and may be set by the user. Once the logging data metadata 106A and/or the application component metadata 106B received from the logging data assemblies 102 is read or reviewed, the user may be able to determine the variables available for searching. For example, the search criteria may include, but is not limited to, corresponding well information, customer information, location information, run information, and/or other variables. In certain embodiments, the Application Program 111 may also display the raw logging data 103 to the user.

In certain embodiments, the Application Program 111 may use the application component metadata 106B to process the raw logging data 103. Specifically, the Application Program 111 may use the application component metadata 106B to convert the raw logging data 103 into an output answer 105. One of functions of the Application Program 111 is to describe the contents of the logging data assemblies 102 to the user. The Application Program 111 may also process the logging data metadata 106A and/or the application component metadata 106B to calculate the output answer 105. The Application Program 111 may include a user interface (not shown) and a display (not shown). In certain implementations, the Application Program 111 may display any one or more of the logging data metadata 106A and/or the application component metadata 106B, or the output answer 105 on the display, in response to a user's request for such information. Specifically, the Application Program 111 may provide a visual representation of the data contained within the Application Program 111.

In certain implementations, the Application Program 111 may be part of a Data Acquisition and Control Interface (“DACI”) (not shown). In certain implementations, the DACI may be an information handling system. As discussed above, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. Suitable data acquisition and control interfaces for use as the DACI include, but are not limited to, Insite® System Manager Calculator provided by Halliburton Energy Services, Inc. of Duncan, Okla. Although certain exemplary systems are disclosed as suitable for use as the DACI, as would be appreciated by those of ordinary skill in the art, having the benefit of the present disclosure, any suitable data acquisition and control system may be used as the DACI without departing from the scope of the present disclosure.

Turning to FIG. 2, method steps in accordance with an exemplary embodiment of the present disclosure are generally denoted with reference numeral 200. At step 202, raw logging data 103, application components 104 including algorithms, logging data metadata 106A, and/or the application component metadata 106B may be provided within the logging data assemblies 102. The logging data assemblies 102 may load the raw logging data 103 and application components 104. The logging data metadata 106A and/or the application component metadata 106B may be generated within the logging data assemblies. Although particular methods of providing the raw logging data 103, application components 104, logging data metadata 106A, and/or the application component metadata 106B are disclosed herein, other implementations and methods of providing such components within the logging data assemblies 102 may be used without departing from the scope of the present disclosure.

At step 204, the logging data metadata 106A and/or the application component metadata 106B may be exported to the Application Program 111 using a reflection mechanism 110. As would be appreciated by one of ordinary skill in the art with the benefit of this disclosure, any reflection mechanism known to those of ordinary skill in the art may be used to read and export the logging data metadata 106A and/or the application component metadata 106B. Specifically, in certain implementations, the reflection mechanism selected may be Microsoft.Net reflection technology, or any other suitable reflection mechanism.

In certain implementations, the logging data metadata 106A and/or the application component metadata 106B from the logging data assemblies 102 may be retrieved in response to commands from the Application Program 111. These commands may be generated automatically and/or in response to input by a user through the user interface. The logging data metadata 106A and/or the application component metadata 106B may be communicated to the Application Program 111 through a wired or wireless communication network or any other suitable communication means. The implementation and operation of such communication means is well known to those of ordinary skill in the art, having the benefit of the present disclosure, and will therefore not be discussed in detail herein.

At step 206, the Application Program 111 may use the logging data metadata 106A and/or the application component metadata 106B to locate the raw logging data 103 and the application components 104, and more particularly, the algorithms within the application components 104.

At step 208, the Application Program 111 may display the logging data metadata 106A and/or the application component metadata 106B to a user. Alternatively, at step 208, the Application Program 111 may sort and/or organize the logging data metadata 106A and/or the application component metadata 106B. Alternatively, at step 208, the Application Program 111 may also sort, organize, and/or display the raw logging data 103 to the user.

At step 210, the Application Program 111 may process the raw logging data 103. Specifically, the Application Program 111 may process the raw logging data 103 using the application component metadata 106B. In certain implementations, the Application Program 111 may convert the raw logging data 103 to an output answer 105 using the application component metadata 106B. The Application Program 111 may use the application component metadata 106B and the relationship metadata contained within such application component metadata 106B to determine how to use the one or more application components 104. The Application Program 111 may carry out one or more calculations depending on the algorithms contained in the one or more application components 104.

Although a number of steps are depicted in FIG. 2, as would be appreciated by those of ordinary skill in the art, having the benefit of the present disclosure, one or more of the recited steps may be eliminated or modified without departing from the scope of the present disclosure. In addition, additional steps may be added without departing from the scope of the present disclosure. For example, in certain implementations, as discussed previously, the Application Program 111 may receive, sort and/or organize the logging data metadata 106A and/or the application component metadata 106B, raw logging data 103, or output answer 105. The Application Program 111 may also display one or more of the logging data metadata 106A and/or the application component metadata 106B, raw logging data 103, and/or output answer 105. In certain implementations, the Application Program 111 may receive one or more search criteria through the user interface. As would be appreciated by one of ordinary skill in the art with the benefit of this disclosure, one or more of the recited steps may be performed in response to commands, including the search criteria provided to the Application Program 111 through the user interface.

In accordance with the present disclosure, the Application Program may be communicatively coupled to the one or more logging data assemblies 102. The one or more logging data assemblies 102 may be located at the rig site or at a remote location depending on user requirements. The Application Program 111 may be located at a rig site or at a remote location depending on user requirements.

As would be appreciated by those of ordinary skill in the art, having the benefit of the present disclosure, the logging data assemblies 102 may be located locally or remotely relative to the Application Program 111 and any suitable wired or wireless communication means may be used to facilitate communication between the logging data assemblies 102 and the Application Program 111.

As would be appreciated by those of ordinary skill in the art, having the benefit of the present disclosure, any suitable processing application software package may be used by the Application Program 111 to process the raw logging data 103 using the application component metadata 106B. In certain implementations, the Application Program 111 may produce output answer 105 that may be presented to the operation personnel in a variety of visual display presentations such as a display or a monitor. In certain embodiments, any of the raw logging data 103, logging data metadata 106A, and/or the application component metadata 106B may be displayed to the operator using a display or a monitor. The data may be presented to the user in a graphical format (e.g., a chart) or in a textual format (e.g., a table of values).

As would be appreciated by those of ordinary skill in the art, with the benefit of this disclosure, one or more information handling systems may be used to implement the methods disclosed herein. Specifically, the one or more information handling systems may include machine-readable instructions to perform the methods disclosed herein. In certain embodiments, the different information handling systems may be communicatively coupled through a wired or wireless system to facilitate data transmission between the different subsystems. Moreover, each information handling system may include computer-readable media to store data generated by the subsystem as well as preset job performance requirements and standards.

Accordingly, a logging data identification system is provided which uses a reflection mechanism to provide self-described information for searching and retrieving logging data from any local or remote data repository. Using the logging data metadata 106A and application component metadata 106B exported by the reflection mechanism, Application Program 111 may receive, sort and/or organize the logging data metadata 106A and/or the application component metadata 106B, raw logging data 103, or output answer 105. The Application Program 111 understands the logging data metadata 106A and application component metadata 106B and processes raw logging data 103 using the application component metadata 106B. The Application Program 111 may also display one or more of the logging data metadata 106A and/or the application component metadata 106B, raw logging data 103, and/or output answer 105. The Application Program 111 may be aware of the inputs and outputs of any algorithms contained within the application components 104 by virtue of the application component metadata 106B. In this manner, a user using the Application Program 111 may have quick and complete access to an extensive array of logging data.

An embodiment of the present disclosure is a method of identifying logging data that includes loading a plurality of raw logging data and one or more application components, generating logging data metadata associated with at least one of raw logging data and generating application component metadata associated with one or more application components, exporting the logging data metadata and application component metadata to an application program using a reflection mechanism, using at least one of the logging data metadata and application component metadata to locate the raw logging data and application components, and processing logging data metadata and application component metadata.

Optionally, the raw logging data, one or more application components, logging data metadata, and application component metadata are provided within one or more logging data assemblies. Optionally, the method further includes the steps of organizing at least one of the group consisting of logging data metadata, application component metadata, and raw logging data, and displaying at least one of the group consisting of logging data metadata, application component metadata, and raw logging data. Optionally, the steps of organizing and displaying are performed in response to search criteria received through a user interface. Optionally, a display is used to display the at least one of the group consisting of logging data metadata, application component metadata, and raw logging data.

Optionally, the method further includes the step of using the application component metadata to convert the raw logging data to an output answer. Optionally, the application program converts the raw logging data to an output answer in response to search criteria received through a user interface. Optionally, the method further includes the step of displaying the output answer.

Another embodiment of the present disclosure is a system for identifying logging data. The system includes one or more logging data assemblies that include a plurality of raw logging data, one or more application components, logging data metadata associated with at least one of the raw logging data, and application component metadata associated with the one or more application components. The system further includes an application program for receiving the logging data metadata and application component metadata using a reflection mechanism, wherein the application program processes the raw logging data.

Optionally, the application program organizes at least one of the group consisting of logging data metadata, application component metadata, and raw logging data. Optionally, the application program displays at least one of the group consisting of logging data metadata, application component metadata, and raw logging data. Optionally, the application program organizes and displays at least one of the group consisting of logging data metadata, application component metadata, and raw logging data in response to search criteria received through a user interface. Optionally, the application program uses the application component metadata to convert the raw logging data to an output answer. Optionally, the application program converts the raw logging data to an output answer in response to search criteria received through a user interface. Optionally, the output answer is displayed. Optionally, the application program is operable to provide complete access to the one or more logging data assemblies.

Another embodiment of the present disclosure is a system for identifying logging data. The system includes one or more logging data assemblies that include a plurality of raw logging data, one or more application components, logging data metadata associated with at least one of the raw logging data, and application component metadata associated with the one or more application components. The system further includes an application program for receiving the logging data metadata and application component metadata using a reflection mechanism; wherein application program uses the application component metadata to convert the raw logging data to an output answer.

Optionally, the application program organizes and displays at least one of the group consisting of logging data metadata, application component metadata, and raw logging data in response to search criteria received through a user interface. Optionally, the application program uses at least one of the group consisting of logging data metadata and application component metadata to locate at least one of the group consisting of the raw logging data and application components. Optionally, the application program is operable to provide complete access to the one or more logging data assemblies.

Therefore, the present disclosure is well-adapted to carry out the objects and attain the ends and advantages mentioned as well as those which are inherent therein. While the disclosure has been depicted and described by reference to exemplary embodiments of the disclosure, such a reference does not imply a limitation on the disclosure, and no such limitation is to be inferred. The disclosure is capable of considerable modification, alteration, and equivalents in form and function, as will occur to those ordinarily skilled in the pertinent arts and having the benefit of this disclosure. The depicted and described embodiments of the disclosure are exemplary only, and are not exhaustive of the scope of the disclosure. The terms in the claims have their plain, ordinary meaning unless otherwise explicitly and clearly defined by the patentee.

What is claimed is:

1. A method of identifying logging data, the method comprising:
loading a plurality of raw logging data and one or more application components;
generating logging data metadata associated with at least one of raw logging data and generating application component metadata associated with one or more application components;
exporting the logging data metadata and application component metadata to an application program using a reflection mechanism;
using at least one of the logging data metadata and application component metadata to locate the raw logging data and application components; and
processing logging data metadata and application component metadata.

2. The method of claim 1, wherein the raw logging data, one or more application components, logging data metadata, and application component metadata are provided within one or more logging data assemblies.

3. The method of claim 1, further comprising the steps of organizing at least one of the group consisting of logging data metadata, application component metadata, and raw logging data, and displaying at least one of the group consisting of logging data metadata, application component metadata, and raw logging data.

4. The method of claim 3, wherein the steps of organizing and displaying are performed in response to search criteria received through a user interface.

5. The method of claim 3, wherein a display is used to display the at least one of the group consisting of logging data metadata, application component metadata, and raw logging data.

6. The method of claim 1, further comprising the step of using the application component metadata to convert the raw logging data to an output answer.

7. The method of claim 6, wherein the application program converts the raw logging data to an output answer in response to search criteria received through a user interface.

8. The method of claim 7, further comprising the step of displaying the output answer.

9. A system for identifying logging data, comprising:
one or more logging data assemblies comprising:
a plurality of raw logging data;
one or more application components; and
logging data metadata associated with at least one of the raw logging data and application component metadata associated with the one or more application components;
an application program for receiving the logging data metadata and application component metadata using a reflection mechanism; wherein the application program processes the raw logging data.

10. The system of claim 9, wherein the application program organizes at least one of the group consisting of logging data metadata, application component metadata, and raw logging data.

11. The system of claim 9, wherein the application program displays at least one of the group consisting of logging data metadata, application component metadata, and raw logging data.

12. The system of claim 9, wherein the application program organizes and displays at least one of the group consisting of logging data metadata, application component metadata, and raw logging data in response to search criteria received through a user interface.

13. The system of claim 9, wherein the application program uses the application component metadata to convert the raw logging data to an output answer.

14. The system of claim 13, wherein the application program converts the raw logging data to an output answer in response to search criteria received through a user interface.

15. The system of claim 13, wherein the output answer is displayed.

16. The system of claim 9, wherein the application program is operable to provide complete access to the one or more logging data assemblies.

17. A system for identifying logging data, comprising:
one or more logging data assemblies comprising:
a plurality of raw logging data;
one or more application components; and
logging data metadata associated with at least one of the raw logging data and application component metadata associated with the one or more application components;
an application program for receiving the logging data metadata and application component metadata using a reflection mechanism; wherein application program uses the application component metadata to convert the raw logging data to an output answer.

18. The system of claim 17, wherein the application program organizes and displays at least one of the group consisting of logging data metadata, application component metadata, and raw logging data in response to search criteria received through a user interface.

19. The system of claim 17, wherein the application program uses at least one of the group consisting of logging data metadata and application component metadata to locate at least one of the group consisting of the raw logging data and application components.

20. The system of claim 17, wherein the application program is operable to provide complete access to the one or more logging data assemblies.
